(19) United States
(12) Patent Application Publication
(10) Pub. No.: US 2007/0257922 A1
(43) Pub. Date: Nov. 8, 2007

(54) REMOVABLE MEDIA DEVICE AND IMAGE DISPLAYING SYSTEM

(75) Inventors: Megumi KAMATA, Nagoya-shi (JP); Fumitoshi UNO, Okazaki-shi (JP)

Correspondence Address: BANNER & WITCOFF, LTD.;ATTORNEYS FOR CLIENT NOS. 0166889, 006760, 1100 13th STREET, N.W., SUITE 1200, WASHINGTON, DC, 20005-4051, US

(73) Assignee: BROTHER KOGYO KABUSHIKI KAISHA, Nagoya-shi (JP)

(21) Appl. No.: 11/686,582

(22) Filed: Mar. 15, 2007

(30) Foreign Application Priority Data
Mar. 15, 2006 (JP) 2006-071499

(51) Int. Cl. G06T 1/00

(52) U.S. Cl. 345/501

(57) ABSTRACT

An image displaying system includes: a removable media device; and an image processor. The image displaying system includes: a filename acquiring unit; a command outputting unit; a reduced image data outputting unit; and a thumbnail displaying unit. The filename acquiring unit acquires filename for each of at least one image file that is stored on the removable medium. The command outputting unit attaches a command requesting data stored in a prescribed region of an image file corresponding to each filename acquired by the filename acquiring unit, and outputs each filename and a command attached thereto. The reduced image data outputting unit outputs the data stored in the prescribed region of the image file corresponding to each filename to the image processor based on the command attached to the each filename and outputted by the command outputting unit. The thumbnail displaying unit displays at least one image corresponding to the at least one image file stored on the removable medium on a single screen of the image processor at a reduced size based on the data outputted by the reduced image data outputting unit.

### CROSS REFERENCE TO RELATED APPLICATION

This application claims priority from Japanese Patent Application No. 2006-71499 filed Mar. 15, 2006. The entire content of this priority application is incorporated herein by reference.

### TECHNICAL FIELD

The invention relates to a removable media device, an image displaying system, a display control method, and a data control method.

### BACKGROUND

Japanese unexamined patent application publication No. 2000-125251 describes one display format enabling d user to easily view a plurality of image files taken on a digital camera or the like on a display screen. According to this method, the image files are reduced in size so that a plurality of images can be displayed on the display screen as thumbnail images.

Further, removable media devices, such as card readers, are used as adapters for reading image files taken with a digital camera or the like on removable medium so that the image files stored on the removable medium can be read into a personal computer for browsing by the user. More recent types of removable media devices well known in the art include a USB removable media device that communicates according to the universal serial bus (USB) communication standard, a shared folder removable media device, and a file transfer protocol (FTP) removable media device.

FIG. 1(a) is a sample screenshot of a personal computer displaying image files read from a conventional USB removable media device as thumbnail images. As shown in FIG. 1(a), image files stored on removable medium mounted in a USB removable media device and a shared folder removable media device can be displayed on the personal computer as thumbnail images (reduced version images).

### SUMMARY

However, as shown in FIG. 1(b), image tiles stored on removable medium used in conventional FTP removable media devices cannot he displayed as thumbnail images. FIG. 1(b) shows the state of image files read from removable medium by a conventional FTP removable media device when displayed on a personal computer screen. As shown in FIG. 1(b), the personal computer cannot receive thumbnail images from a removable media device based on FTP and must display a prescribed icon in place of the thumbnail images.

Consequently, in order to specify image files to be browsed from among image data on a single removable medium and identify all image data, the user must check each image data file one at a time, requiring significant time and effort.

While it is conceivable to employ a method of reading all image data on the removable medium and generate and display thumbnail images on the personal computer, this configuration would require that all image files on the removable medium be transmitted to the personal computer, requiring a lot of data transfer time and taking significant time before the thumbnail images are displayed.

In view of the foregoing, it is an object of the present invention to provide a removable media device, an image displaying system, a data control method, and a display control method enabling a user to browse image files stored on removable medium mounted in a removable media device quickly and easily, even when using a removable media device that outputs data stored on the removable medium via a network employing FTP.

In order to attain the above and other objects, the invention provides an image displaying system including: a removable media device that is configured to output data stored on removable medium via a network; and an image processor that is connected to the removable media device via the network and that is configured to display an image on a screen according to data outputted from the removable media device. The image displaying system includes: a filename acquiring unit; a command outputting unit; a reduced image data outputting unit; and a thumbnail displaying unit. The filename acquiring unit acquires filename for each of at least one image file that is stored on the removable medium. The command outputting unit attaches a command requesting data stored in a prescribed region of an image file corresponding to each filename acquired by the filename acquiring unit, and outputs each filename and a command attached thereto. The reduced image data outputting unit outputs the data stored in the prescribed region of the image file corresponding to each filename to the image processor based on the command attached to the each filename and outputted by the command outputting unit. The thumbnail displaying unit displays at least one image corresponding to the at least one image file stored on the removable medium on a single screen of the image processor at a reduced size based on the data outputted by the reduced image data outputting unit.

According to another aspect, the invention provides an image displaying system, including: a removable media device that is configured to be capable of outputting data stored on removable medium to an image processor via a network; and the image processor that is connected to the removable media device via the network and that is configured to be capable of displaying images on a screen based on inputted data. The image processor includes a transmitting unit transmitting at least one filename each being attached with a prescribed command. The removable media device includes a reduced image data outputting unit outputting data stored in a prescribed region of each of at least one image file stored on the removable medium and corresponding to the received at least one filename attached with the prescribed command. The image processor further includes a display unit receiving the data outputted from the reduced image data outputting unit and displaying at least one image corresponding to the at least one image file on a single screen at a reduced size.

According to another aspect, the invention provides a removable media device that can output data stored on removable medium. The removable media device includes: a removable medium receiving unit receiving a removable medium; and a reduced image data outputting unit outputting data stored in a prescribed region of an image file corresponding to filename of each of at least one image file stored on the removable medium when the filename attached with a prescribed command is received.

According to another aspects the invention provides a display control method implemented on an image displaying system including an image processor and a removable media device, the image processor being connected, via a network, to the removable media device, the removable media device being configured to output data stored on removable medium, the image processor being configured to display an image on a screen according to data outputted from the removable media device. The display control method includes: controlling the image processor to acquire, from the removable media device, filename for each of at least one image file that is stored on a removable medium; controlling the image processor to attach a command requesting data stored in a prescribed region of an image file corresponding to each filename acquired, and to output each filename and a command attached thereto; and controlling the image processor to display, based on data outputted from the removable media device in response to the command, at least one image corresponding to the at least one image file stored on the removable medium on a single screen of the image processor at a reduced size based on the outputted data.

According to another aspect, the invention provides a data control method implemented on an image displaying system including a removable media device and an image processor that are connected with each other via a network, the image processor being configured to be capable of displaying images on a screen based on inputted data, the removable media device being configured to be capable of outputting data stored on removable medium to the image processor via the network. The data control method includes: controlling a removable media device to output, to the image processor, data stored in a prescribed region of an image file corresponding to filename of each of at least one image file stored on a removable medium when the filename, attached with a prescribed command, is received from an image processor; and controlling the image processor to display, based on the data outputted from the removable media device, at least one image corresponding to the at least one image file stored on the removable medium on a single screen at a reduced size.

According to another aspect, the invention provides a display control method implemented on an image processor that is configured to display an image on a screen according to data. The display control method includes: acquiring filename for each of at least one image file that is stored on a removable medium; attaching a command requesting data stored in a prescribed region of an image file corresponding to each filename acquired, and outputting each filename and a command attached thereto; and receiving data in response to the command, and displaying at least one image corresponding to the at least one image file stored on the removable medium on a single screen of the image processor at a reduced size based on the received data.

According to another aspect, the invention provides a data control method implemented on a removable media device that can output data stored on removable medium. The data control method includes: outputting data that is stored in a prescribed region of an image file corresponding to filename of each of at least one image file stored on a removable medium, upon receiving the filename, attached with a prescribed command, the data stored in the prescribed region of the image file indicating an image of a reduced size corresponding to the image file.

According to another aspect, the invention provides a storage medium storing a set of program instructions executable on an image processor that is configured to display an image on a screen according to data, the instructions including: acquiring filename for each of at least one image file that is stored on a removable medium; attaching a command requesting data stored in a prescribed region of an image file corresponding to each filename acquired, and outputting each filename and a command attached thereto; and receiving data in response to the command, and displaying at least one image corresponding to the at least one image file stored on the removable medium on a single screen of the image processor at a reduced size based on the received data.

According to another aspect, the invention provides a storage medium storing a set of program instructions executable on a removable media device that can output data stored on removable medium, the instructions including: outputting data that is stored in a prescribed region of an image file corresponding to filename of each of at least one image file stored on a removable medium, upon receiving the filename, attached with a prescribed command, the data stored in the prescribed region of the image file indicating an image of a reduced size corresponding to the image file.

### BRIEF DESCRIPTION OF THE DRAWINGS

In the drawings:

FIG. 1(a) is a sample screenshot on the display screen of a personal computer showing image files read from a conventional USB removable media device and displayed as thumbnail images;

FIG. 1(b) is a sample screenshot on the display screen of a personal computer showing image files read from a conventional FTP removable media device;

FIG. 2 is a block diagram showing the structure of an image displaying system according to an embodiment of the present invention;

FIG. 3 is an explanatory diagram illustrating a display screen for thumbnail images displayed on the display panel of a personal computer;

FIG. 4 is an explanatory diagram conceptually illustrating the structure of an image file in the JPEG format stored on a memory card;

FIG. 5 is an explanatory diagrams conceptually illustrating processes executed on a multifunction peripheral and the personal computer;

FIG. 6 is a flowchart illustrating steps in a process performed on the personal computer to display thumbnail images; and

FIG. 7 is a flowchart illustrating steps in a process executed on the multifunction peripheral for outputting thumbnail image data.

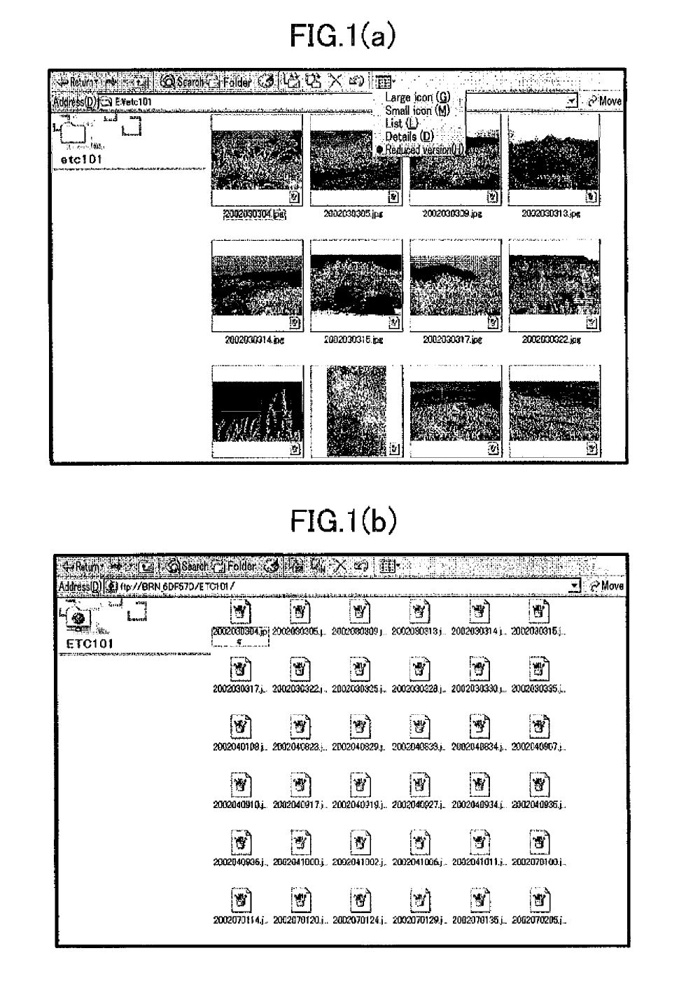

### DETAILED DESCRIPTION

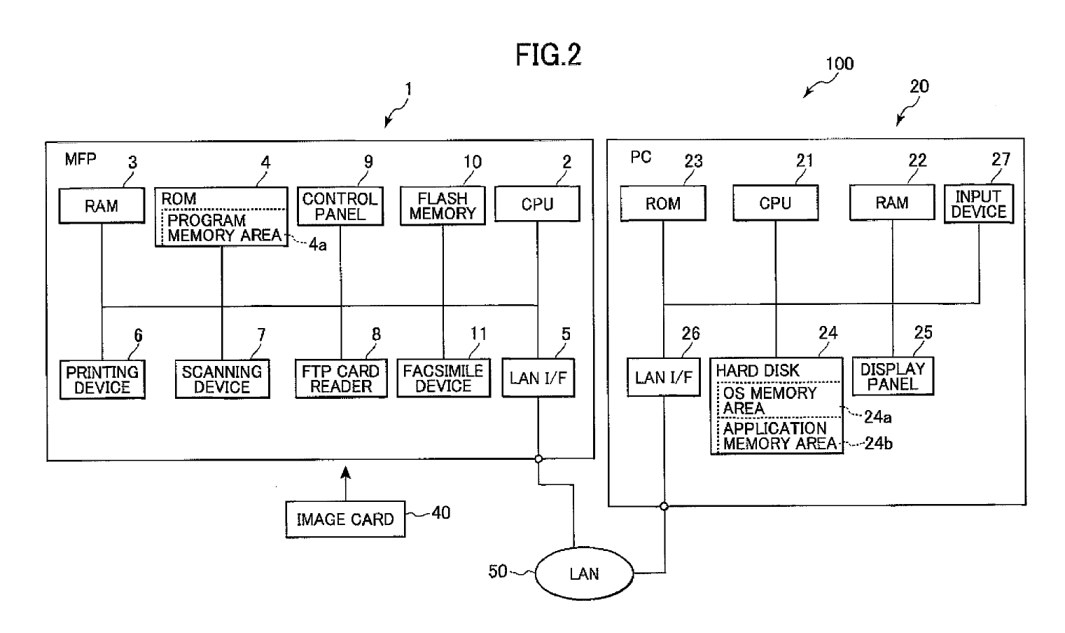

Next, an embodiment of the present invention will be described while referring to the accompanying drawings. FIG. 2 is a block diagram showing an image displaying system 100 according to the embodiment. As shown in FIG. 2, the image displaying system 100 is configured of a multifunction peripheral 1 that functions as a removable media device, and a personal computer 20 connected to the multifunction peripheral 1 via a local area network (LAN) 50 that functions as an image processor.

The multifunction peripheral 1 includes various functions in one unit, including a photomedia capture function, a printer function, a copier function, a scanner function, and a facsimile function. As shown in FIG. 2, the multifunction peripheral 1 includes primarily: a CPU 2 that controls the overall operations of the multifunction peripheral 1; a RAM 3, which is a memory functioning to temporarily store data and the like required in various processes executed by the CPU 2; a ROM 4 for storing various control programs executed by the CPU 2 and fixed value data; a LAN interface 5; a printing device 6; a scanning device 7; an FTP card reader 8; a control panel 9 configured of a plurality of input keys (buttons and switches) that allow the users to implement various functions on the multifunction peripheral 1, and a display screen; a flash memory 10; and a facsimile device 11 for transmitting and receiving image data through a telephone line (not shown).

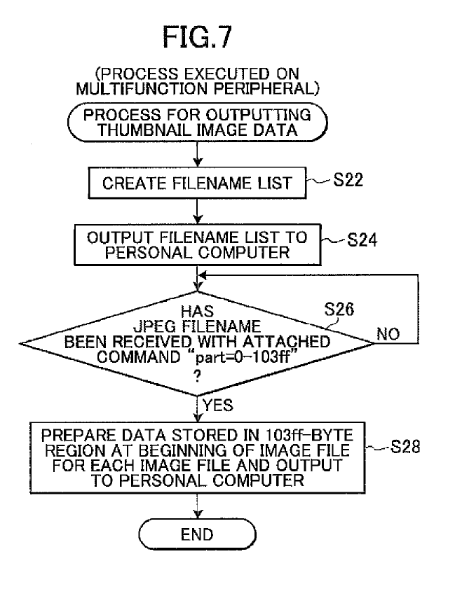

The CPU 2 is a processor that executes various programs stored in the ROM 4. The RAM 3 is a random access memory that includes a work area for temporarily storing variables and the like when the CPU 2 executes programs. The ROM 4 includes a program memory area 4a storing various programs, including a program for executing the process shown in the flowchart of FIG. 7.

The control panel 9 includes the plurality of operating keys and the display screen. The user can input instructions in the multifunction peripheral 1 by manipulating the keys. The operating keys include mode selection keys for selecting such functions as the photomedia capture function, copier function, scanner function, and facsimile function; and a ten-key pad for inputting alphanumeric characters. By operating the mode selection keys, the user can set the multifunction peripheral 1 to a photomedia capture mode implementing the photomedia capture function, a copier mode implementing the copier function, a scanner mode implementing the scanner function, or a facsimile mode implementing the facsimile function.

By manipulating the keys in the ten-key pad, the user can input a facsimile number to which a facsimile is to be transmitted, or a number of copies when performing a copy operation. The display screen displays an options screen indicating user settings and the like, for example.

The flash memory 10 is a nonvolatile memory capable of storing various data that can be written thereto and read therefrom. The flash memory 10 stores a network address (IP address) or a node name for the multifunction peripheral 1 on the LAN 50.

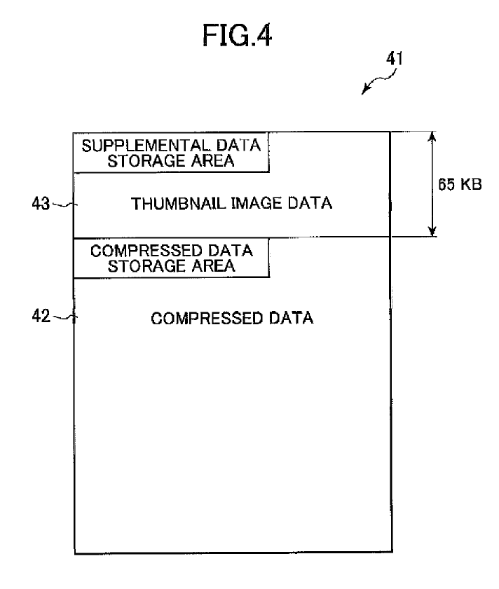

The LAN interface 5 facilitates communications via the LAN 50. In the embodiment, the protocol for file transfers used by the LAN 50 is the file transfer protocol (FTP). When the multifunction peripheral 1 is set in the photomedia capture mode and an image card 40 (removable medium) is inserted in the FTP card reader 8, image files 41 (FIG. 4) stored on the image card 40 can be outputted to the personal computer 20 connected to the LAN 50 via the LAN interface 5.

The printing device 6 is an inkjet printer for printing images on a recording paper set at a prescribed feeding position (not shown) based on instructions from the CPU 2. The printing device 6 includes a paper-conveying motor (not shown) for conveying the recording paper, a print head (not shown) for ejecting ink onto the recording paper, and a carriage motor (not shown) for moving a carriage (not shown) on which the print head is supported. When the multifunction peripheral 1 is set in the photomedia capture mode and the image card 40 is inserted into the FTP card reader 8, the printing device 6 can directly print the image files 41 (see FIG. 4) stored on the image card 40.

The scanning device 7 reads an image from an original set at a prescribed scanning position (not shown) based on instructions from the CPU 2. When the multifunction peripheral 1 is set in the copier mode, the printing device 6 prints image data generated by the scanning device 7 on recording paper. If the multifunction peripheral 1 is set in the scanner mode, image data generated by the scanning device 7 is stored in a prescribed storage area of the RAM 3 and subsequently transferred to the personal computer 20 or the like via the LAN 50.

The FTP card reader 8 includes a plurality of slots in which various types of image cards 40 can be detachably inserted. The FTP card reader 8 can read data stored on the image card 40 mounted in one of the slots and can write desired data to the same. When the multifunction peripheral 1 is set in the photomedia capture mode, the CPU 2 can read data from the image card 40 mounted in the FTP card reader 8 and direct the printing device 6 to print this data or output the data to the personal computer 20 via the LAN 50. The image card 40 is configured of flash memory that is rewritable and can preserve data when the power to the multifunction peripheral 1 is cut off. The image card 40 may be one of various types provided from different companies, such as the SD Card and the xD Card.

The image card 40 includes a data memory area storing the image files 41 (see FIG. 4) taken by a digital camera or the like and text data or other data created on a computer, for example. The multifunction device 1 employs the FAT (File Allocation Table) as a file system for managing the image files 41 in the image card 40.

The facsimile device 11 functions to transmit image data read by the scanning device 7 or other data received via the LAN 50 to another facsimile device via a telephone line. Data received by the facsimile device 11 through the telephone line can be printed on the printing device 6 or transmitted to the personal computer 20 via the LAN 50.

Next, the structure of the personal computer 20 will be described. The personal computer 20 includes: a CPU 21; a RAM 22, a memory that functions to temporarily store data, programs, and the like required in various processes executed by the CPU 21; a ROM 23 for storing various control programs executed by the CPU 21 and fixed value data; a hard disk 24, which is a nonvolatile rewritable memory device for storing various settings; an input device 27 configured of a keyboard and mouse having a plurality of input keys for setting various functions; the display panel 25 configured of a liquid crystal display and functioning to display various data; and a LAN interface 26 for establishing a connection with the LAN 50.

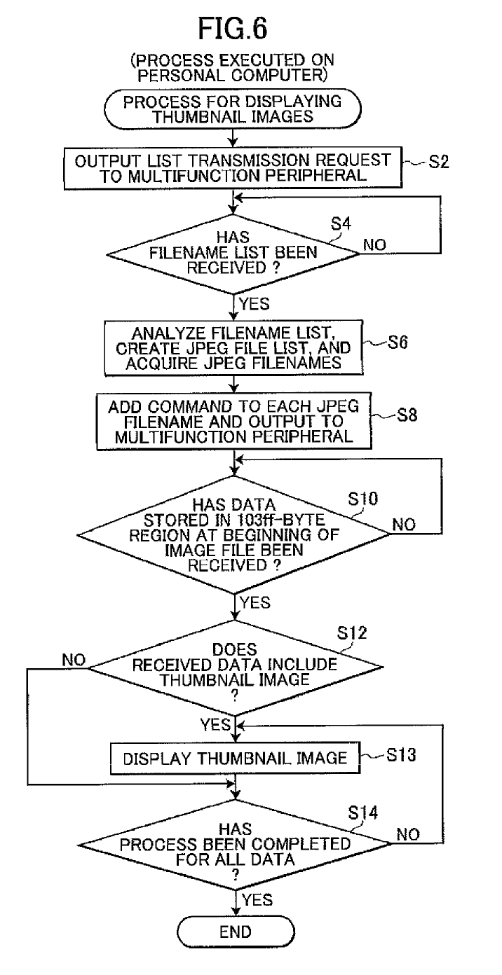

The hard disk 24 includes an OS memory area 24a for storing an operating system (OS), and an application memory area 24b for storing various application programs (hereinafter abbreviated as “applications”). In the embodiment, the application memory area 24b stores an image browsing application for implementing the process shown in the flowchart of FIG. 6. The image browsing application displays a plurality of images corresponding to the plurality of image files 41 (see FIG. 4) on the image card 40 in a single screen on the display panel 25 at a reduced size, enabling the user to browse the images.

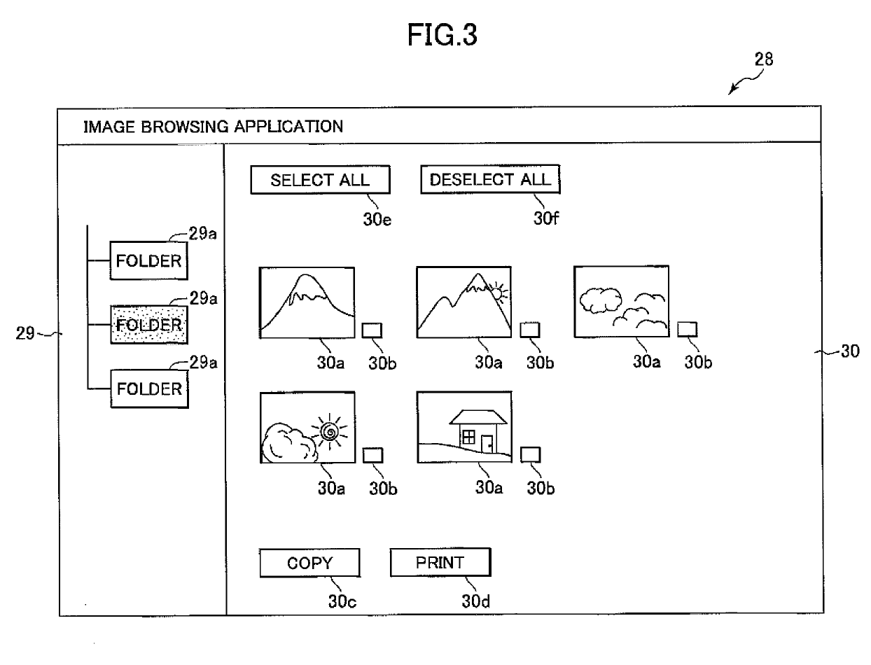

Next, an overview of the processes performed on the multifunction peripheral 1 and personal computer 20 will be described with reference to FIG. 3 through FIG. 5.

FIG. 3 shows an example of a thumbnail image display screen 28 displayed on the display panel 25 of the personal computer 20. As shown in FIG. 3, the thumbnail image display screen 28 is configured of a directory tree display region 29 displayed in the left side of the display panel 25, and a thumbnail image display region 30 displayed to the right of the directory tree display region 29. The directory tree display region 29 displays folder icons 29a symbolizing the plurality of folders stored on the image card 40 in a tree structure. The thumbnail image display region 30 displays thumbnail images 30a of the image files 41 stored on the image card 40, The thumbnail image display screen 28 is displayed when the image browsing application stored in the application memory area 24b is started.

The tree structure display in the directory tree display region 29 allows the user to visually perceive the hierarchical structure of folders stored on the image card 40.

If the user clicks on one of the folder icons 29a displayed in the directory tree display region 29, the plurality of image files 41 in the folder corresponding to the selected folder icon 29a are displayed in reduced form in the thumbnail image display region 30. Each of the images reduced in size and displayed in the thumbnail image display region 30 for the image files 41 is represented by a thumbnail image 30a.

By looking over the plurality of thumbnail images 30a displayed in the thumbnail image display region 30, the user can quickly and easily determine which of the image files 41 are stored in the selected folder.

As shown in FIG. 3, a checkbox 30b is displayed next to each of the thumbnail images 30a in the thumbnail image display region 30 for selecting the corresponding thumbnail image 30a. The user selects a thumbnail image 30a by inserting a check in the checkbox 30b provided next to the desired thumbnail image 30a with a mouse click, for example. If the user subsequently clicks on a Copy button 30c displayed in the bottom of the thumbnail image display region 30 while a check is inserted in one of the checkboxes 30b, the image file 41 corresponding to the thumbnail image 30a next to the checked checkbox 30b is read out from the memory card and copied in a prescribed location on the personal computer 20.

However, if the user clicks a Print button 30d displayed to the right of the Copy button 30c while a check is inserted in one of the checkboxes 30b, then the image file 41 corresponding to the selected thumbnail image 30a is printed with the printing device 6 of the multifunction peripheral 1.

In addition, a Select All button 30e and a Deselect All button 30f are displayed at the top of the thumbnail image display region 30. If the user clicks on the Select All button 30e, a check is inserted in all checkboxes 30b displayed in the thumbnail image display region 30. However, if the user selects the Deselect All button 30f, checks are removed from all checkboxes 30b displayed in the thumbnail image display region 30. Hence, the user can select or deselect all thumbnail images 30a through a simple operation.

It is necessary to acquire thumbnail image data to display the thumbnail images 30a on the personal computer 20. In this example, thumbnail image data is pre-stored at the beginning of each JPEG (Joint Photographic Experts Group) image file 41 taken by the digital camera. Hence, in the image displaying system 100 according to the embodiment, this thumbnail image data stored in the image files 41 is read and used to display the thumbnail images 30a on the personal computer 20.

FIG. 4 is a conceptual image of an image file 41 stored on the image card 40. As shown in FIG. 4, the image file 41 is configured of a compressed data storage area 42 storing compressed data corresponding to a static image, and a supplemental data storage area 43 preceding the compressed data storage area 42 and storing supplemental data on the compressed data. Thumbnail image data (reduced data indicative of a reduced image for the static image indicated by the compressed data in the compressed data storage area 42) is included in the image file 41 within the supplemental data storage area 43, at a region that includes a maximum of 65 KB from the beginning of the image file 41. Therefore, in order to output the thumbnail image data stored in the image file 41 of the JPEG format to the personal computer 20, data stored in the 65-KB region at the head of the image tile 41 that includes the thumbnail image data is outputted to the personal computer 20.

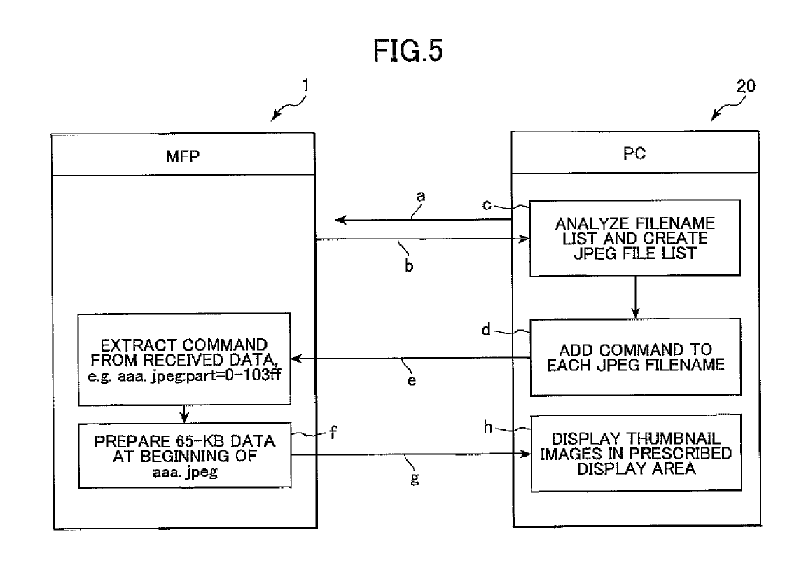

Next, the overall process of displaying the thumbnail images 30a on the thumbnail image display region 30 will be described with reference to FIG. 5. FIG. 5 conceptually illustrates an outline of the processes executed on the multifunction peripheral 1 and the personal computer 20.

When the user clicks on a folder icon 29a in the tree structure (see FIG. 3) displayed on the personal computer 20, the personal computer 20 outputs a list transmission request to the multifunction peripheral 1 requesting a list of filenames corresponding to the folder on the image card 40 represented by the selected folder icon 29a [a].

In the embodiment, the list transmission request is a command requesting a list of filenames for all files stored in a folder on the image card 40 corresponding to the clicked folder icon 29a, regardless of whether the files are of the JPEG format.

Upon receiving the list transmission request, the multifunction peripheral 1 creates a list of filenames for the corresponding folder in the image card 40 and transmits this list to the personal computer 20 that issued the request [b].

Upon receiving the list of filenames from the multifunction peripheral 1, the personal computer 20 analyzes the list, and creates a JPEG file list describing filenames for image files 41 of the JPEG format (hereinafter referred to as “JPEG filenames”) that exist among all the filenames in the received filename list, thereby acquiring JPEG filenames [c]. The personal computer 20 attaches a command “part=0-133ff” to each of the acquired JPEG filenames [d]. At this time, the symbol “:” is added between the command “part=0-133ff” and the filename as a separator. For example, when the command is attached to the JPEG filename “aaa.jpeg” the result is “aaa.jpeg:part=0-133ff.”

The personal computer 20 transmits the JPEG filenames with the command attached to each to the multifunction peripheral 1 [e]. Upon receiving the command attached with JPEG filename, the multifunction peripheral 1 separates the JPEG filename and command “part=0-103ff,” with the separator “:” functioning as a carriage return (linefeed). Here, the symbol “:” used as the separator can be used as a character in a filename according to the FTP protocol, but is not recognized as part of the filename in the file system used on the multifunction peripheral 1 (FAT in the embodiment). Hence, the JPEG filename with attached command (such as “aaa.jpeg:part=0-103ff”) passes as an integrated filename in FTP protocol when transmitted to the multifunction peripheral 1, but functions as a separator in the multifunction peripheral 1.

Based on the command “part=0-103ff” separated from the JPEG filename by the separator “:”, the multifunction peripheral 1 prepares the data stored in a 103ff-byte (about 65 KB) region at the beginning of the image file 41 specified by the JPEG filename (such as “aaa.jpeg”) for each specified JPEG image file 41 [f]. The multifunction peripheral 1 outputs this prepared data to the personal computer 20 [g]. As described above, image files 41 of the JPEG format hold thumbnail image data in a 65-KB region at the beginning thereof. Hence, the multifunction peripheral 1 can reliably output thumbnail image data to the personal computer 20 by outputting the data stored in the 103ff-byte region at the beginning of each image file 41 to the personal computer 20. Upon receiving this data from the multifunction peripheral 1, the personal computer 20 displays thumbnail images 30a in the thumbnail image display region 30 (see FIG. 3) based on the thumbnail image data [h].

While the overall process performed on the personal computer 20 and the multifunction peripheral 1 has been described above, below the individual processes executed on the personal computer 20 and the multifunction peripheral 1 will be described in greater detail with reference to FIG. 6 and FIG. 7, respectively.

FIG. 6 is a flowchart illustrating steps in a thumbnail image displaying process performed on the personal computer 20. The process for displaying thumbnail images begins when the user clicks on one of the folder icons 29a displayed on the personal computer 20 in the directory tree display region 29.

In S2 of the process in FIG. 6, the CPU 21 of the personal computer 20 requests a list of filenames corresponding to the folder icon 29a the user has clicked by outputting a list transmission request to the multifunction peripheral 1. In S4 the CPU 21 waits to receive a list of filenames from the multifunction peripheral 1 in response to the list transmission request. If a list of filenames is received from the multifunction peripheral 1 (S4: YES), then in S6 the CPU 21 analyzes the received list of filenames, creates the JPEG file list, and acquires JPEG filenames.

Next, in S8 the CPU 21 adds the command “part=0-103ff” and the separator “:” to separate the command from the filename to each JPEG filename acquired in S6 and outputs the results to the multifunction peripheral 1. In S10 the CPU 21 waits until data stored in the 103ff-byte region at the beginning of the image file 41 is received from the multifunction peripheral 1 in response to the command “part=0-103ff.” When this data has been received (S10: YES), in S12 the CPU 21 determines whether the received data includes thumbnail image data.

If the data includes thumbnail image data (312: YES), then in S13 the CPU 21 displays the thumbnail image 30a on the thumbnail image display region 30 (FIG. 3) based on the thumbnail image data. In S14 the CPU 21 determines whether all data has been processed. If processing has not been completed for all data (514: NO), the CPU 21 returns to S12. However, if processing has been completed for all data (S14: YES), then the CPU 21 ends the process.

FIG. 7 is a flowchart illustrating steps in a process for outputting thumbnail image data executed on the multifunction peripheral 1. This process is initiated when the multifunction peripheral 1 receives a list transmission request from the personal computer 20.

Upon receiving a list transmission request from the personal computer 20, in S22 the CPU 2 of the multifunction peripheral 1 extracts filenames of files stored in the folder on the image card 40 corresponding to the folder icon 29a that was clicked on the PC 20 in the thumbnail image display screen 28, and creates a list of these filenames. In S24 the CPU 2 transmits the created list of filenames to the personal computer 20 from which the list transmission request originated.

In S26 the CPU 2 waits until a JPEG filename with the attached command “part=0-103ff” has been received. When a JPEG filename with this command has been received (S26: YES), in S28 the CPU 2 prepares data stored in the 103ff-byte region at the beginning of the image file 41 identified by the JPEG filename for each identified image file 41 based on the command “part=0-103ff” and outputs the results to the personal computer 20. Through this process, the personal computer 20 can display a plurality of the image files 41 from the folder corresponding to the selected folder icon 29a at a reduced size in the thumbnail image display region 30.

As described above in the embodiment, the multifunction peripheral 1 can output thumbnail image data to the personal computer 20 by outputting the data stored in a 103ff-byte region at the beginning of each image file 41 to the personal computer 20.

Hence, even if the multifunction peripheral 1 outputs data stored on the image card 40 via a network using the FTP protocol, the user can confirm the image files 41 on the image card 40 quickly and easily.

While the invention has been described in detail with reference to the embodiment thereof, it would be apparent to those skilled in the art that various changes and modifications may be made therein without departing from the spirit of the invention.

For example, the FTP card reader 8 in the embodiment is incorporated in the multifunction peripheral 1. However, instead of the FTP card reader 8, it is possible to use a device functioning as a standalone card reader or card reader/writer.

Further, in the embodiment described above, the JPEG image data always includes thumbnail image data. However, some JPEG image files do not hold thumbnail image data. In such cases, the multifunction peripheral 1 may generate thumbnail image data and output this data to the personal computer 20 instead of outputting the data stored in the 65-KB region at the beginning of the file. In this way, the multifunction peripheral 1 outputs less data to the personal computer 20 than when the image files are outputted to the personal computer 20 in their entirety, thereby shortening the amount of time required for data communications and enabling the user to confirm the image files 41 on the image card 40 quickly and easily.

Further, in the embodiment described above, 65 KB of data are outputted from the beginning of the JPEG image file. However, the multifunction peripheral 1 may be configured to output an amount of data less than or greater than 65 KB, provided that the data is outputted from a region including thumbnail image data.

Further, if the JPEG image files 41 do not include thumbnail image data, the multifunction peripheral 1 may be configured to transmit fixed data to the personal computer 20 for displaying a fixed icon. Alternatively, the personal computer 20 may be configured to display an icon with a simple fixed design when the received data does not include thumbnail image data.

Instead of “:”, at least one character and/or at least one symbol may be used as a separator that can be recognized by the FTP as a part of a filename and therefore that passes through the FTP, but that cannot be recognized as part of a filename by the FAT and therefore can be recognized as a separator for separating filename and command in the FAT.

Further, FAT is used as the tile system in the embodiment, but the present invention may be applied to a configuration using the NTFS (NT File System) or other file system.

In the embodiment, the protocol for file transfers used by the LAN 50 is the file transfer protocol (FTP). However, the LAN 50 may use protocols other than FTP.

In the embodiment described above, upon receiving the list of filenames from the multifunction peripheral 1, the personal computer 20 analyzes the list, and creates the JPEG file list describing filenames for image files 41 of the JPEG format that exist among all the filenames in the received filename list, thereby acquiring JPEG filenames. However, the personal computer 20 may create another file list describing filenames for image files of any other desirable formats that exist among all the filenames in the received filename list, thereby acquiring filenames of the desirable formats. The personal computer 20 attaches a command to each of the acquired filenames, and transmits the filenames with the command attached to each to the multifunction peripheral 1. Upon receiving the command attached with filename, the multifunction peripheral 1 separates the filename and command. Based on the command separated from the filename, the multifunction peripheral 1 prepares thumbnail image data that is stored in a predetermined region of the image file specified by the filename for each specified image file. That is, the multifunction peripheral 1 outputs a proper amount of data from the predetermined region of the image file that includes thumbnail image data. The predetermined region may be defined at the beginning of the image file, or may be defined at another area of the image file. The multifunction peripheral 1 outputs this prepared thumbnail image data to the personal computer 20. Upon receiving this data from the multifunction peripheral 1, the personal computer 20 displays thumbnail images in the thumbnail image display region 30 based on the thumbnail image data.

What is claimed is:

1. An image displaying system including: a removable media device that is configured to output data stored on removable medium via a network; and an image processor that is connected to the removable media device via the network and that is configured to display an image on a screen according to data outputted from the removable media device, the image displaying system comprising:
a filename acquiring unit acquiring filename for each of at least one image tile that is stored on the removable medium;
a command outputting unit attaching a command requesting data stored in a prescribed region of an image file corresponding to each filename acquired by the filename acquiring unit, and outputting each filename and a command attached thereto;
a reduced image data outputting unit outputting the data stored in the prescribed region of the image file corresponding to each filename to the image processor based on the command attached to the each filename and outputted by the command outputting unit; and
a thumbnail displaying unit displaying at least one image corresponding to the at least one image file stored on the removable medium on a single screen of the image processor at a reduced size based on the data outputted by the reduced image data outputting unit.

2. An image displaying system according to claim 1, wherein the image processor includes the filename acquiring unit, the command outputting unit, and the thumbnail displaying unit, and the removable media device includes the reduced image data outputting unit.

3. An image displaying system, comprising:
a removable media device that is configured to be capable of outputting data stored on removable medium to an image processor via a network; and
the image processor that is connected to the removable media device via the network and that is configured to be capable of displaying images on a screen based on inputted data,
the image processor including a transmitting unit transmitting at least one filename each being attached with a prescribed command,
the removable media device including a reduced image data outputting unit outputting data stored in a prescribed region of each of at least one image file stored on the removable medium and corresponding to the received at least one filename attached with the prescribed command,
the image processor further including a display unit receiving the data outputted from the reduced image data outputting unit and displaying at least one image corresponding to the at least one image file on a single screen at a reduced size.

4. An image displaying system according to claim 3, wherein the transmitting unit transmits the filename and the prescribed command that is separated from the filename by a character or a symbol that passes as part of the filename in the network but is not recognized as part of the filename in a file system used on the removable media device.

5. An image displaying system according to claim 4, wherein the transmitting unit transmits the filename and the prescribed command with a “:” being added as a separator between the filename and prescribed command.

6. An image displaying system according to claim 5, wherein the removable media device employs a file system that is configured of the File Allocation Table (FAT).

7. A removable media device that can output data stored on removable medium, the removable media device comprising:
a removable medium receiving unit receiving a removable medium; and
a reduced image data outputting unit outputting data stored in a prescribed region of an image file corresponding to filename of each of at least one image file stored on the removable medium when the filename attached with a prescribed command is received.

8. A removable media device according to claim 7, wherein the reduced image data outputting unit outputs the data stored in the prescribed region of the image file corresponding to the filename, upon receiving, via a network, the filename and the prescribed command that is separated from the filename by a character or a symbol that passes as part of the filename in the network but is not recognized as part of the filename in a file system used on the removable media device.

9. A removable media device according to claim 8, wherein the reduced image data outputting unit outputs the data stored in the prescribed region of the image file corresponding to the filename when the filename and the prescribed command are received with a “:” being added as a separator between the filename and prescribed command.

10. A removable media device according to claim 9, wherein the removable media device employs a file system that is configured of the File Allocation Table (FAT).

11. A display control method implemented on an image displaying system including an image processor and a removable media device, the image processor being connected, via a network, to the removable media device, the removable media device being configured to output data stored on removable medium, the image processor being configured to display an image on a screen according to data outputted from the removable media device, the display control method comprising:
controlling the image processor to acquire, from the removable media device, filename for each of at least one image file that is stored on a removable medium;
controlling the image processor to attach a command requesting data stored in a prescribed region of an image file corresponding to each filename acquired, and to output each filename and a command attached thereto; and
controlling the image processor to display, based on data outputted from the removable media device in response to the command, at least one image corresponding to the at least one image file stored on the removable medium on a single screen of the image processor at a reduced size based on the outputted data.

12. A display control method according to claim 11, wherein the command outputting step adds a character or a symbol as a separator for separating the filename and the command, the character or the symbol passing as part of the filename in the network but being not recognized as part of the filename in a file system used on the removable media device.

13. A display control method according to claim 12, wherein the command outputting step adds a “:” as the separator between the filename and the command.

14. A display control method according to claim 13, wherein the removable media device employs a file system that is configured of the File Allocation Table (FAT).

15. A data control method implemented on an image displaying system including a removable media device and an image processor that are connected with each other via a network, the image processor being configured to be capable of displaying images on a screen based on inputted data, the removable media device being configured to be capable of outputting data stored on removable medium to the image processor via the network, the data control method comprising:
controlling a removable media device to output, to the image processor, data stored in a prescribed region of an image file corresponding to filename of each of at least one image file stored on a removable medium when the filename, attached with a prescribed command, is received from an image processor; and
controlling the image processor to display, based on the data outputted from the removable media device, at least one image corresponding to the at least one image file stored on the removable medium on a single screen at a reduced size.

16. A data control method according to claim 15, wherein the reduced image data outputting step outputs the data stored in the prescribed region of the image file corresponding to the filename, upon receiving the filename and the prescribed command that is separated from the filename by a character or a symbol that passes as part of the filename in the network but is not recognized as part of the filename in a file system used on the removable media device.

17. A data control method according to claim 16, wherein the reduced image data outputting step outputs the data stored in the prescribed region of the image file corresponding to the filename when the filename and the prescribed command are received with a “:” being added as a separator between the filename and prescribed command.

18. A data control method according to claim 17, wherein the removable media device employs a file system that is configured of the File Allocation Table (FAT).

19. A display control method implemented on an image processor that is configured to display an image on a screen according to data, the display control method comprising:
acquiring filename for each of at least one image file that is stored on a removable medium;
attaching a command requesting data stored in a prescribed region of an image file corresponding to each filename acquired, and outputting each filename and a command attached thereto; and
receiving data in response to the command, and displaying at least one image corresponding to the at least one image file stored on the removable medium on a single screen of the image processor at a reduced size based on the received data.

20. A display control method according to claim 19, wherein the command outputting step adds a character or a symbol as a separator for separating the filename and the command, and outputs the filename and the command to a network, the character or the symbol passing as part of the filename in the network.

21. A display control method according to claim 20, wherein the command outputting step adds a “:” as the separator between the filename and the command.

22. A data control method implemented on a removable media device that can output data stored on removable medium, the data control method comprising:
outputting data that is stored in a prescribed region of an image file corresponding to filename of each of at least one image file stored on a removable medium, upon receiving the filename, attached with a prescribed command, the data stored in the prescribed region of the image file indicating an image of a reduced size corresponding to the image file.

23. A data control method according to claim 22, wherein the data outputting step outputs the data stored in the prescribed region of the image file corresponding to the filename, upon receiving, via a network, the filename and the prescribed command that is separated from the filename by a character or a symbol that passes as part of the filename in the network but is not recognized as part of the filename in a file system used on the removable media device.

24. A data control method according to claim 23, wherein the data outputting step outputs the data stored in the prescribed region of the image file corresponding to the filename when the filename and the prescribed command are received with a “:” being added as a separator between the filename and prescribed command.

25. A data control method according to claim 24, wherein the removable media device employs a file system that is configured of the File Allocation Table (FAT).

26. A storage medium storing a set of program instructions executable on an image processor that is configured to display an image on a screen according to data, the instructions comprising:
acquiring filename for each of at least one image file that is stored on a removable medium;
attaching a command requesting data stored in a prescribed region of an image file corresponding to each filename acquired, and outputting each filename and a command attached thereto; and
receiving data in response to the command, and displaying at least one image corresponding to the at least one image file stored on the removable medium on a single screen of the image processor at a reduced size based on the received data.

27. A storage medium storing a set of program instructions executable on a removable media device that can output data stored on removable medium, the instructions comprising:
outputting data that is stored in a prescribed region of an image file corresponding to filename of each of at least one image file stored on a removable medium, upon receiving the filename, attached with a prescribed command, the data stored in the prescribed region of the image file indicating an image of a reduced size corresponding to the image file.
